(19) United States
(12) Patent Application Publication
(10) Pub. No.: US 2010/0052914 A1
(43) Pub. Date: Mar. 4, 2010

(54) Portable body temperature continuous monitoring system

(76) Inventor: Chi-Sheng Tsai, Taipei City (TW)

Correspondence Address: Chi-Sheng ,TSAI, P.O. BOX 46-563 Taipei,, Taipei City, 104, TW

(21) Appl. No.: 12/229,858

(22) Filed: Aug. 28, 2008

(51) Int. Cl. G08B 23/00

(52) U.S. Cl. 340/573.1; 340/584

(57) ABSTRACT

A portable body temperature continuous monitoring system includes a wearable thermal detecting device, a recording device, a displaying device and an alarming device. The recording device records and stores a human body temperature detected by the wearable thermal detecting device, and then transmits a temperature signal to the displaying device and the alarming device through a wireless method. Thereby, remote and continuous monitoring of a patient's body temperature through the displaying device is possible. Besides, since the system is capable of communicating outward through the alarming device, the patient's abnormal body temperature can be reported to others so that proper treatment can be conducted timely.

### BACKGROUND OF THE INVENTION

1. Technical Field

The present invention relates to body temperature monitoring systems, and more particularly, to a portable body temperature monitoring system capable of continuously detecting and recording human body temperature.

2. Description of Related Art

Abnormal variation of human body temperature is often considered a warning of virus-incurred or bacterial infection and thus human body temperature is one of the important bases for identifying human physical disorder. Conventionally, mercury-in-glass thermometers, electronic thermometers and ear thermometers are used to measure human body temperature at different body parts to get, for example, axillary temperature, oral temperature, rectal temperature and ear temperature. However, the above-recited thermometers can only take one-time measurement and display the presently measured body temperature, but fail to continuously record measured data in an automatic manner. Therefore, in the event that a patient's long-term body temperature variation is to be tracked, the medical staff members or caregivers related to the patient have to take the measurement regularly at a certain frequency and record each reading manually. Meantime, such periodical measuring process can cause significant trouble and disturbance to bed-ridden, aged and disabled patients. Besides, since the conventional devices have no solution to continuously monitoring patients' body temperature variation, it is difficult to detect abnormal variation timely and give proper treatment immediately.

### SUMMARY OF THE INVENTION

One objective of the present invention is to provide a portable body temperature monitoring system that primarily comprises a wearable thermal detecting device, a recording device, a displaying device and an alarming device. Thermal detecting elements are provided on the wearable thermal detecting device so that when the wearable thermal detecting device is worn by a user, the thermal detecting elements detect the user's body temperature at the user's two axillae. Then the recording device records and stores the detected body temperature as a temperature signal, and transmits the temperature signal to the displaying device and the alarming device so that the presently detected body temperature is displayed in an alphabetical or numeric form through the displaying device. When the temperature signal received by the alarming device is determined as abnormal, the alarming device gives out a warning, such as an alarming sound or a pre-recorded voice warning, through an amplifier. With the disclosed system, it is possible to continuously monitor patients' body temperature variation and remotely observe the patents' present body temperature so as to save caregivers' labor and energy consumed by repeatedly measuring and manually recording body temperature as required by the conventional devices.

Another objective of the present invention is to provide the portable body temperature monitoring system wherein when the temperature signal received from the recording device by the alarming device is determined as being abnormal, and the alarming device gives out the alarming sound or the pre-recorded voice warning through the amplifier, a telecom interface integrated with a telephone dials a preset phone number and sends out a voice message to report the abnormal temperature signal to a hospital or a first-aid provider immediately.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a broad systemic block diagram of the present invention;

FIG. 2 is a detailed systemic block diagram of the present invention;

FIG. 3 is a drawing showing the present invention worn by a user;

FIG. 4 is a perspective view of a wearable thermal detecting device of the present invention;

FIG. 5 is a perspective view of a recording device of the present invention;

FIG. 6 is a systemic block diagram of the recording device of the present invention;

FIG. 7 is a systemic block diagram of a displaying device of the present invention;

FIG. 8 is a systemic block diagram of an alarming device of the present invention;

FIG. 9 is a block diagram showing the recording device and the displaying device in wireless communication;

FIG. 10 is a schematic drawing showing the recording device and the displaying device in wireless communication;

FIG. 11 is a block diagram showing the recording device and the alarming device in wireless communication;

FIG. 12 is a schematic drawing showing the recording device and the alarming device in wireless communication; and

FIG. 13 is a schematic drawing showing the alarming device being operated.

### DETAILED DESCRIPTION OF THE PREFERRED EMBODIMENTS

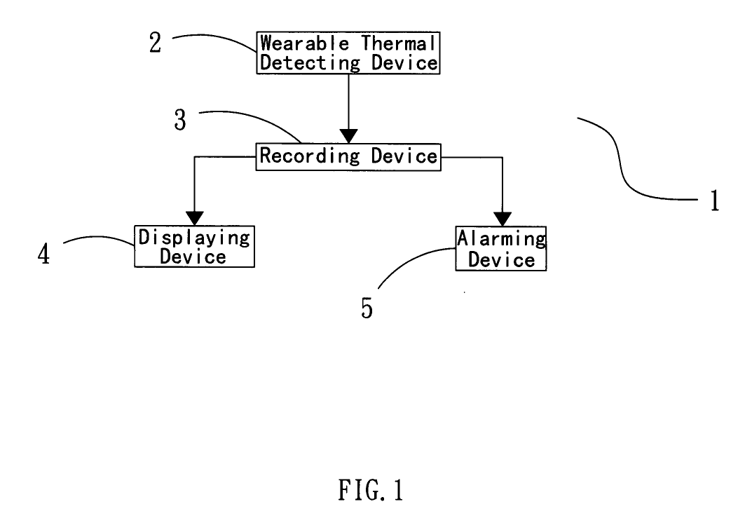

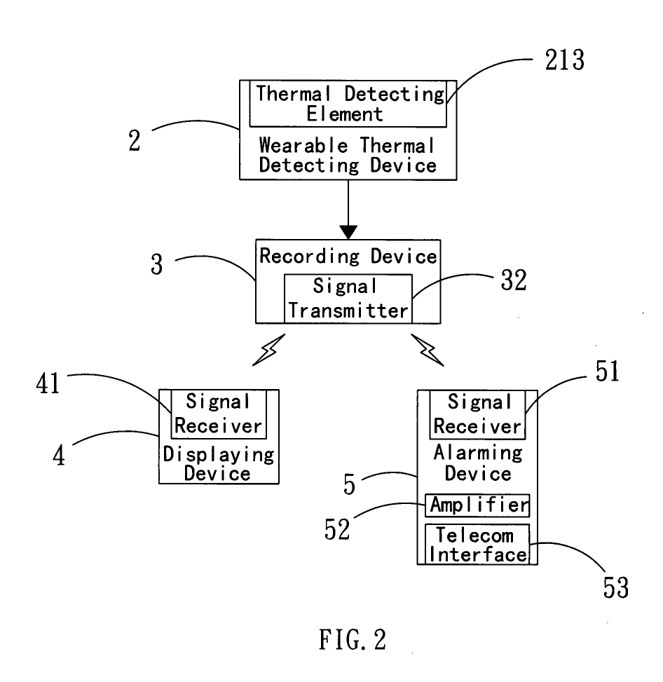

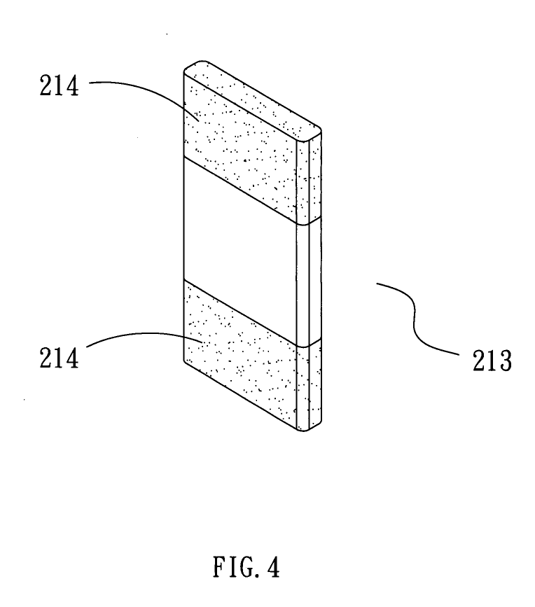

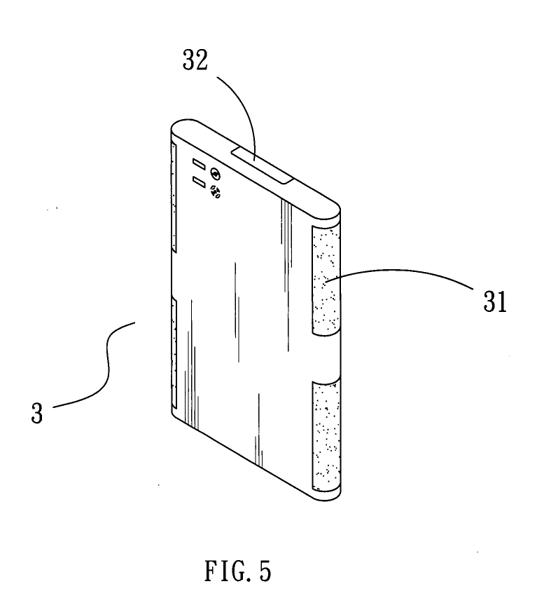

Please refer to FIGS. 1, 2, 3, 4 and 5 for graphic illustration of the present invention. According to the drawings, a portable body temperature monitoring system 1 primarily comprises a wearable thermal detecting device 2, a recording device 3, a displaying device 4 and an alarming device 5. Therein, the wearable thermal detecting device 2 is substantially a cloth piece 21 equipped with an accommodating pocket 211 that is made of stainless steel staple fibers. At leas one conductor 212 that is made of stainless steel staple fibers extends from the accommodating pocket 211 to portions of the cloth piece 21 corresponding in position to two axillae of a user wearing the cloth piece 21. At each of the portions of the cloth piece 21 corresponding in position to the user's two axillae, a thermal detecting element 213 is arranged that has a connecting end 214 made of a nickel-based conductive paste conductively connecting the conductor 212. Besides, the recording device 3 has at least one receiving end 31 made of a nickel-based conductive paste and a signal transmitter 32. The recording device 3 is received in the accommodating pocket 211 on the cloth piece 21 so that the receiving end 31 of the recording device 3 connects with the accommodating pocket 211 and the conductor 212. The displaying device 4 and the alarming device 5 are each provided with a signal receiver 41, 51 for receiving a temperature signal sent out by the recording device 3. Furthermore, the alarming device 5 includes an amplifier 52 and a telecom interface 53.

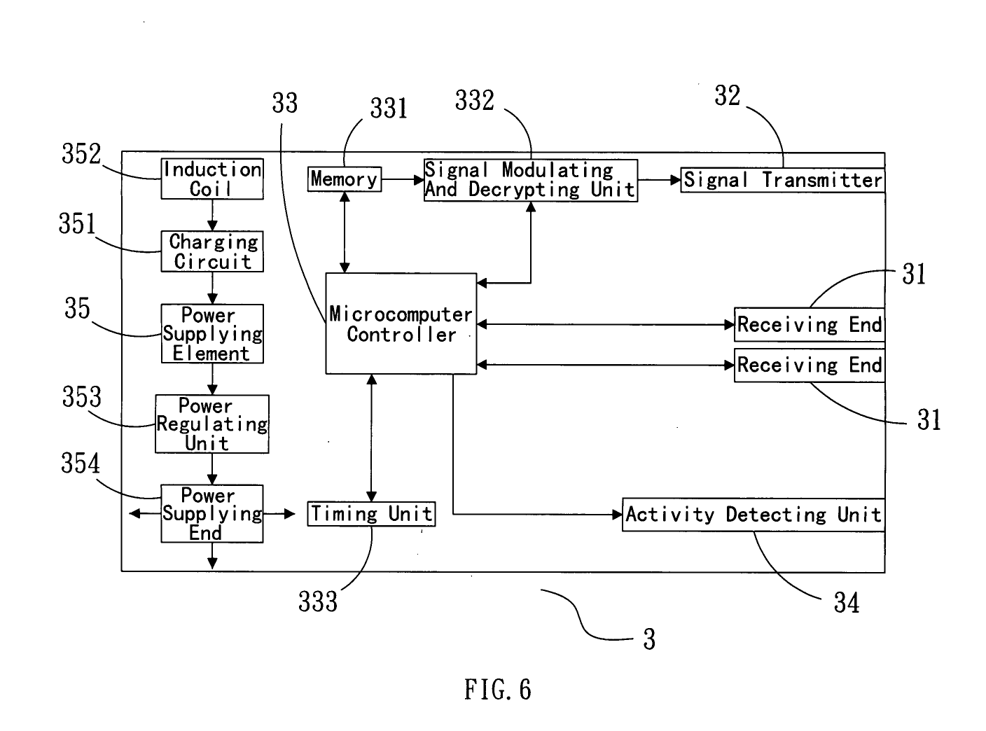

Referring to FIG. 6, according to a partial block diagram of the disclosed system, in addition to the at last one receiving end 31 and the signal transmitter 32, the recording device 3 further comprises therein a microcomputer controller 33, a memory 331, a signal modulating and decrypting unit 332, a timing unit 333, an activity detecting unit 34, a power supplying element 35, a charging circuit 351, an induction coil 352, a power regulating unit 353 and a power supply end 354.

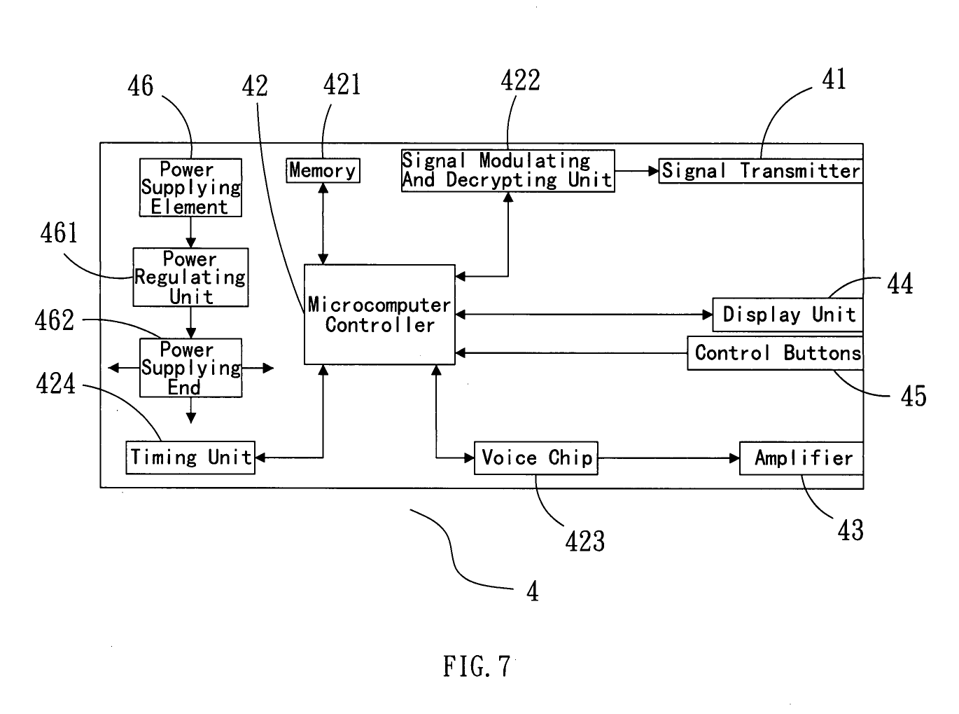

Please see FIG. 7 for another partial block diagram of the present invention. As can been seen in the drawing, in addition to the signal receiver 41, the displaying device 4 further contains a microcomputer controller 42, a memory 421, a signal modulating and decrypting unit 422, a voice chip 423, a timing unit 424, an amplifier 43, a display unit 44, a plurality of control buttons 45, a power supplying element 46, a power regulating unit 461 and a power supply end 462.

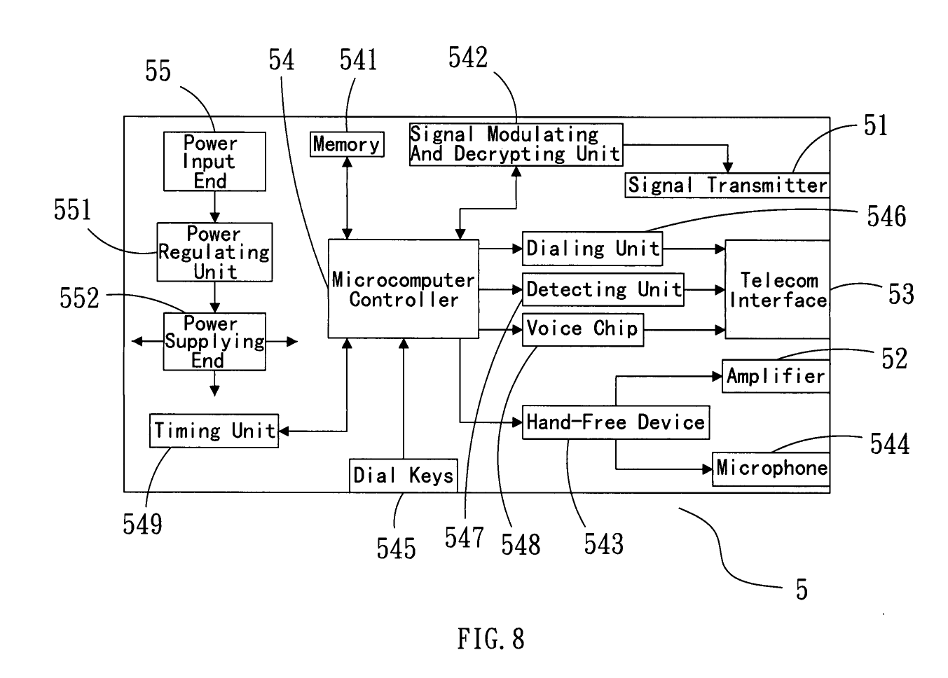

Now reference is made to FIG. 8, which is another partial block diagram of the present invention. As shown in the drawing, in addition to the signal receiver 51, the amplifier 52 and the telecom interface 53, the alarming device 5 also has a microcomputer controller 54, a memory 541, a signal modulating and decrypting unit 542, a hand-free device 543, a microphone 544, a plurality of dial keys 545, a dialing unit 546, a detecting unit 547, a voice chip 548, a timing unit 549, a power input end 55, a power regulating unit 551 and a power supply end 552.

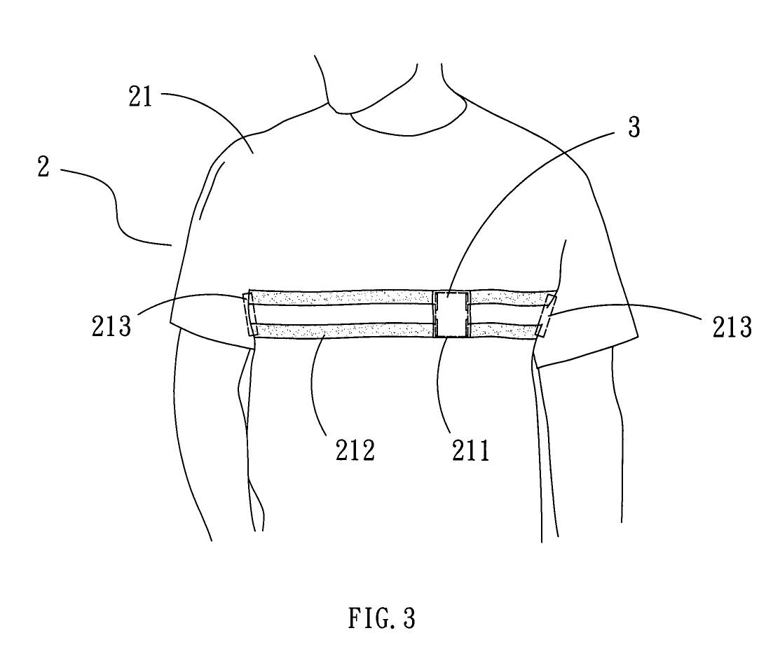

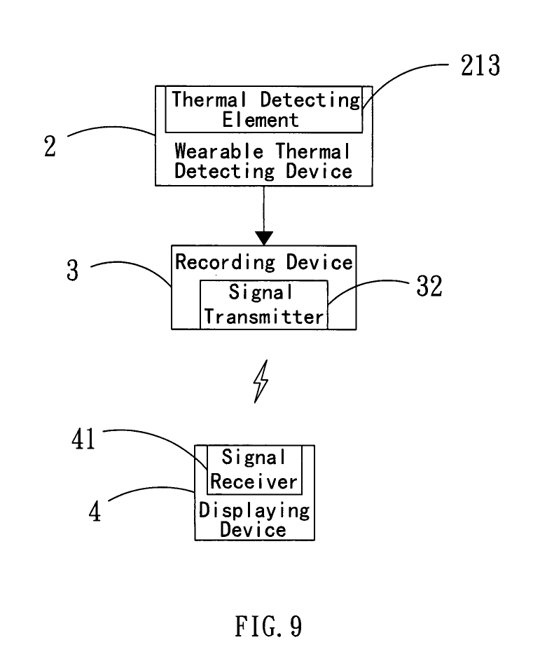

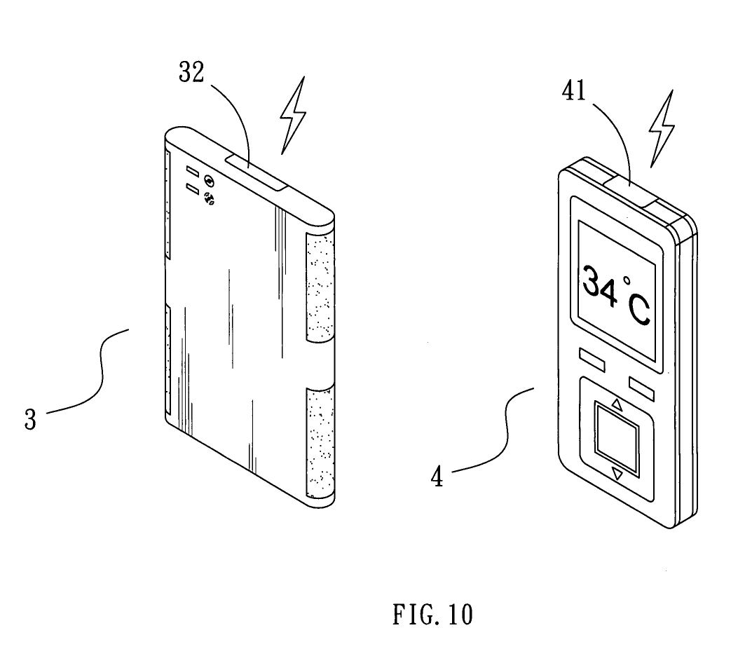

Referring now to FIGS. 9 and 10 in conjunction with FIGS. 3, 4 and 5, it can be clearly seen that when the cloth piece 21 of the wearable thermal detecting device 2 is worn by a patient who may be bed-ridden, aged and disabled, the thermal detecting elements 213 corresponding in position to the patient's two axillae detect the patient's body temperature as a temperature signal. Then the connecting ends 214 of the thermal detecting elements 213 transmit the detected temperature signal to the accommodating pocket 211 through the conductor 212. Afterward, the recording device 3 uses its receiving end 31 to receive the temperature signal from the accommodating pocket 211 or the conductor 212, and further records and stores the received temperature signal. Following that, the signal transmitter 32 of the recording device 3 sends out the temperature signal in a wireless manner and the displaying device 4 receives the temperature signal through its signal receiver 41 and display the patient's present body temperature in an alphabetical or numeric form. Thereby, there is no need for medical staff members or caregivers to manually take the patient's body temperature on a regular basis. Instead, the patient's body temperature variation can be remotely monitored by viewing the patient's present body temperature displayed on the displaying device 4. Thus, the present invention is capable of saving caregivers' labor and freeing patients from being disturbed while they are resting.

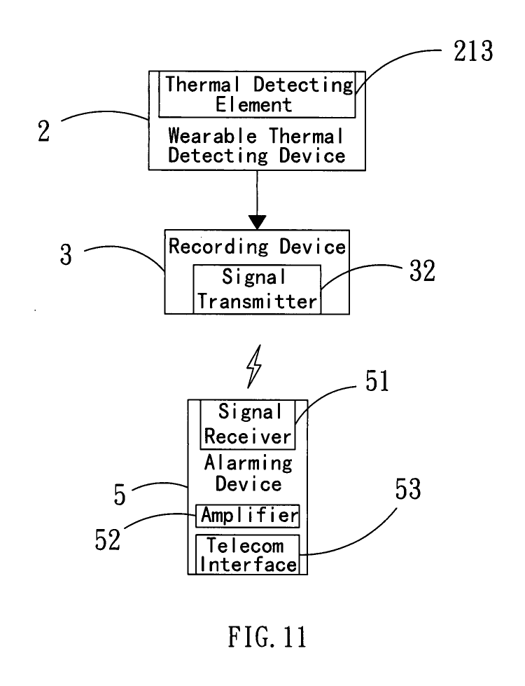

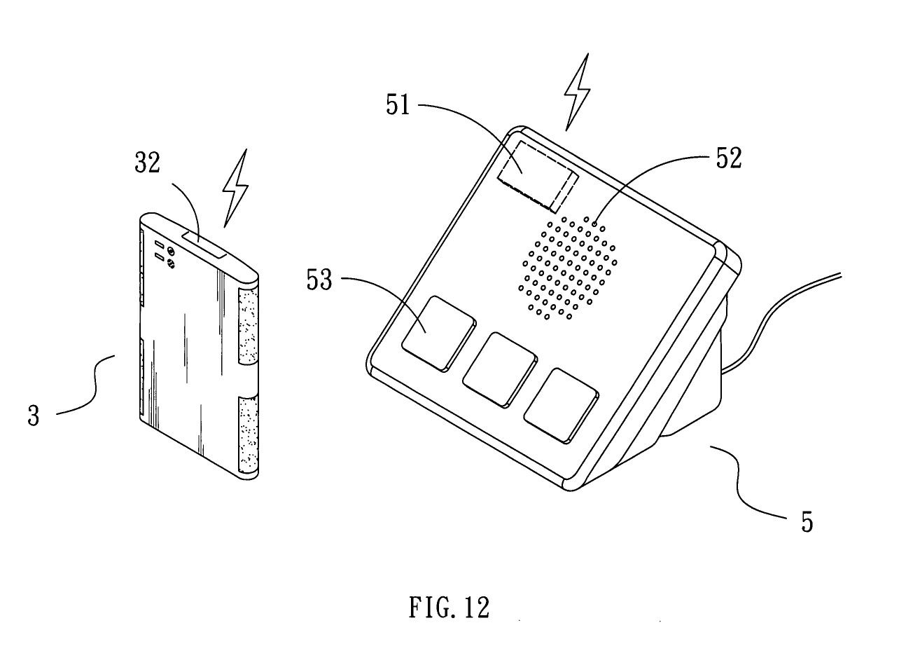

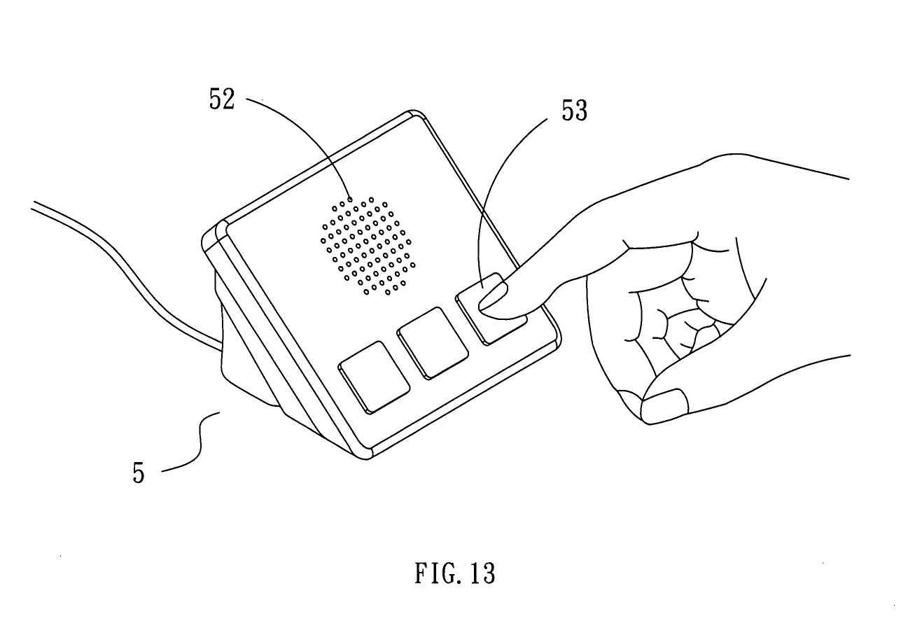

Referring to FIGS. 11, 12 and 13 in conjunction with FIGS. 3, 4 and 5, it can be clearly seen that when the cloth piece 21 of the wearable thermal detecting device 2 is worn by a patient who may be bed-ridden, aged and disabled, the thermal detecting elements 213 corresponding in position to the patient's two axillae detect the patient's body temperature. Then the connecting ends 214 of the thermal detecting elements 213 transmit the detected temperature as a temperature signal to the accommodating pocket 211 through the conductor 212. Afterward, the recording device 3 uses its receiving end 31 to receive the temperature signal from the accommodating pocket 211 or the conductor 212, and further records and stores the received temperature signal. Following that, the signal transmitter 32 of the recording device 3 sends out the temperature signal in a wireless manner and the alarming device 5 receives the temperature signal through its signal receiver 51. Since the alarming device 5 is equipped with the amplifier 52 and the telecom interface 53, in the event that the temperature signal received by the alarming device 5 is determined as abnormal, the alarming device 5 gives an alarming sound or a pre-recorded voice warning through the amplifier 52 so as to inform related medical staff members or caregivers of the abnormal temperature variation and enable proper treatment to be conducted instantly. Meanwhile, the telecom interface 53 integrated with a telephone serves to dial a preset phone number and send out a voice message so as to report the abnormal temperature variation to a hospital or a first-aid provider immediately.

What is claimed is:

1. A portable body temperature continuous monitoring system, comprising:
a wearable thermal detecting device, for being worn by a person to continuously detect body temperature of the person;
a recording device, for recording and storing the body temperature detected by the wearable thermal detecting device as a temperature signal;
a displaying device, for receiving the temperature signal from the recording device and displaying the person's present body temperature in a real-time manner; and
an alarming device, for receiving the temperature signal from the recording device, and giving out a warning immediately when the temperature signal is abnormal.

2. The portable body temperature continuous monitoring system of claim 1, wherein the wearable thermal detecting device comprises:
a cloth piece, equipped with an accommodating pocket and at least one conductor extending from the accommodating pocket to a portion of the cloth piece corresponding in position to an axilla of the person; and
at least one thermal detecting element, provided at the portion of the cloth piece corresponding in position to the person's axilla and having a contacting end for connecting with the conductor.

3. The portable body temperature continuous monitoring system of claim 2, wherein the accommodating pocket and the conductor are made of stainless steel staple fibers.

4. The portable body temperature continuous monitoring system of claim 2, wherein the connecting end of the thermal detecting element is made of a nickel-based conductive paste.

5. The portable body temperature continuous monitoring system of claim 2, wherein the accommodating pocket is provided for receiving the recording device.

6. The portable body temperature continuous monitoring system of claim 1, wherein the recording device has at least one receiving end.

7. The portable body temperature continuous monitoring system of claim 6, wherein the receiving end is made of a nickel-based conductive paste.

8. The portable body temperature continuous monitoring system of claim 1, wherein the recording device has a signal transmitter.

9. The portable body temperature continuous monitoring system of claim 1, wherein the recording device further comprises a microcomputer controller, a memory, a signal modulating and decrypting unit, a timing unit, an activity detecting unit, a power supplying element, a charging circuit, an induction coil, a power regulating unit and a power supply end.

10. The portable body temperature continuous monitoring system of claim 1, wherein the displaying device further comprises a signal receiver.

11. The portable body temperature continuous monitoring system of claim 1, wherein the displaying device displays the person's body temperature in an alphabetical or numeric form.

12. The portable body temperature continuous monitoring system of claim 1, wherein the displaying device further comprises a microcomputer controller, a memory, a signal modulating and decrypting unit, a voice chip, an amplifier, a display unit, a plurality of control buttons, a power supplying element, a power regulating unit and a power supply end.

13. The portable body temperature continuous monitoring system of claim 1, wherein the alarming device comprises:
a signal receiver, for receiving the temperature signal from the recording device;
an amplifier, for giving out an alarming sound or a voice warning when the temperature signal is abnormal; and
a telecom interface, to be integrated with a telephone for dialing a preset pone number and giving out a voice message.

14. The portable body temperature continuous monitoring system of claim 1, wherein the alarming device further comprises a microcomputer controller, a memory, a signal modulating and decrypting unit, a hand-free device, a microphone, a plurality of dial keys, a dialing unit, a detecting unit, a voice chip, a timing unit, a power input end, a power regulating unit and a power supply end.
